(19) United States
(12) Patent Application Publication
(10) Pub. No.: US 2007/0168606 A1
(43) Pub. Date: Jul. 19, 2007

(54) Storage device using nonvolatile cache memory and control method thereof

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/640,199

(22) Filed: Dec. 18, 2006

(30) Foreign Application Priority Data
Jan. 17, 2006 (JP) 2006-009043

(51) Int. Cl. G06F 13/00

(52) U.S. Cl. 711/113

(57) ABSTRACT

In a storage device, a high-speed read/write operation and low power consumption are realized and the service life of a storage medium which is a semiconductor memory can be made longer. The storage device includes a host interface, a command analyzing section which analyzes the contents of a command input from the host interface, a state determining section which determines the rotation state of a hard disk when a command analyzed by the command analyzing section is a command for instructing data writing, and a write processing section which transfers write data to the hard disk when the determination result of the state determining section indicates that the hard disk is being rotated and transfers the write data to the flash memory when the determination result indicates that the hard disk is not being rotated.

### CROSS-REFERENCE TO RELATED APPLICATIONS

This application is based upon and claims the benefit of priority from Japanese Patent Application No. 2006-009043, filed Jan. 17, 2006, the entire contents of which are incorporated herein by reference.

### BACKGROUND

1. Field

One embodiment of the invention relates to a storage device using nonvolatile cache memory and a control method thereof which are designed to realize low power consumption and high-speed write operation and attain a long service life of a storage medium.

2. Description of the Related Art

In recent years, a storage device on which both of a memory card which is a semiconductor storage medium and a hard disk (HD) drive using a hard disk which is a magnetic storage medium can be mounted is developed (refer to Jpn. Pat. Appln. KOKAI Publication No. 2004-055102). For example, data of the memory card fetched from the exterior can be backed up into the hard disk (HD) which is a magnetic storage medium. Further, data of the hard disk (HD) can be transferred to the memory card and can thus be taken out.

As a mobile storage device, a storage device using a flash memory is developed (refer to Japanese Patent Publication No. 3407317). A large number of errors occur in the flash memory when the number of erase operations of the flash memory becomes large (for example, 100,000 times), and therefore, an attempt is made to solve the above problem. For example, a data management method for suppressing the number of erase operations only for a specified area from becoming larger is provided.

### BRIEF SUMMARY OF THE INVENTION

An object of the embodiments of the present invention is to provide a storage device using a nonvolatile cache memory to realize the low power consumption and high-speed read/write operation and attain the long service life of a storage medium which is a semiconductor memory by skillfully utilizing the features of a semiconductor memory and hard disk used as storage media and a control method thereof.

According to one aspect of the present invention, there is provided a storage device comprising a host interface, a command analyzing section which analyzes the contents of a command input from the host interface, a memory interface used as an interface with respect to a cache memory, a state determining section which determines a rotating state of a hard disk when the command analyzed by the command analyzing section is a command instructing a data write operation, and a write processing section which transfers write data to the hard disk when the determination result of the state determining section indicates that the hard disk is being rotated and transfers the write data to the cache memory when the determination result indicates that the hard disk is not being rotated.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the whole configuration of one embodiment according to this invention.

FIG. 2 is a diagram for illustrating the feature of a flash memory shown in FIG. 1.

FIG. 3 is a diagram for illustrating the functions of a flash memory interface and controller 311 shown in FIG. 1.

FIG. 4 is a flowchart for illustrating one example of the operation of a device shown in FIG. 1.

FIG. 5 is a flowchart for illustrating another example of the operation of the device shown in FIG. 1.

FIG. 6 is a flowchart for illustrating still another example of the operation of the device shown in FIG. 1.

### DETAILED DESCRIPTION

Various embodiments according to the invention will be described hereinafter with reference to the accompanying drawings.

<Whole Configuration and Function>

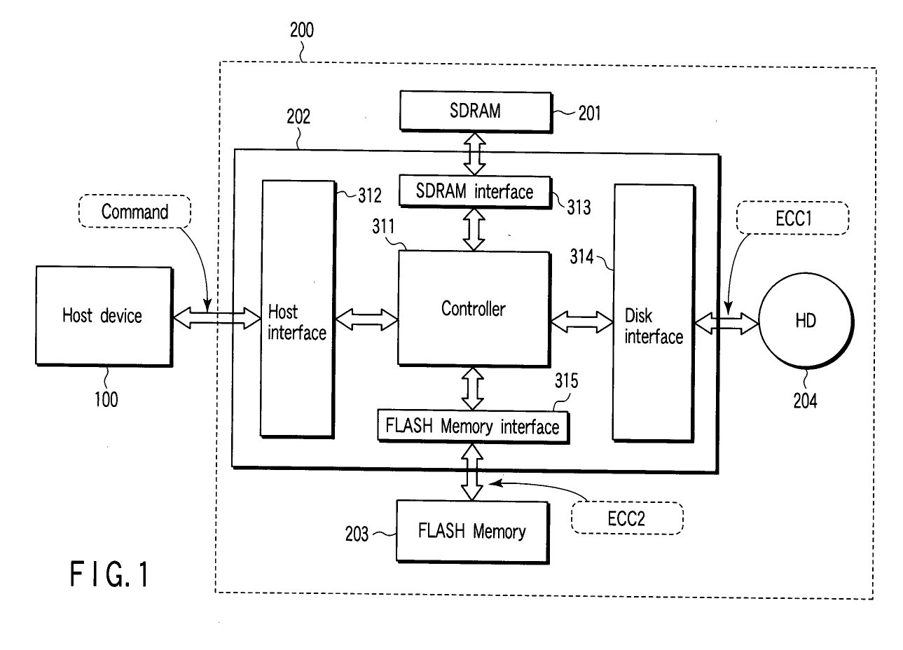

First, one example of a whole block of one embodiment is explained with reference to FIG. 1. A reference symbol 100 denotes a host device which is a control section in a personal computer, for example. A reference symbol 200 denotes a storage device using a nonvolatile cache memory. The storage device 200 includes an SDRAM 201 functioning as a buffer, for example, a one-chip large-scale integrated (LSI) circuit 202 on which a controller and the like which will be described later are mounted, flash memory 203, and hard disk (HD) 204. The flash memory 203 is a nonvolatile cache memory.

The LSI 202 includes a controller 311, host interface 312, SDRAM interface 313, disk interface 314 and flash memory interface 315. The SDRAM 201 may be contained in the LSI 202.

The host device 100 can supply a command to the controller 311 via the host interface 312. Further, the host device 100 can receive data from the controller 311 via the host interface 312 and transfer data to the controller 311 side.

Commands used by the host device 100 and controller 311 contain a data write command, data read command, data size specifying command, data transferring command, data storing command and a command for reading out information from a memory. The controller 311 interprets the command from the host device 100 and performs the data write process, read process, transfer process and the like.

The controller 311 can transfer data with respect to the SDRAM 201 via the SDRAM interface 313. Further, the controller 311 can transfer data with respect to the hard disk (HD) 204 via the disk interface 314. In addition, the controller 311 can transfer data with respect to the flash memory 203 via the flash memory interface 315. Data to be stored in the flash memory 203 is stored therein after an error correcting code is added thereto. Also, data to be stored in the hard disk is stored therein after an error correcting code (ECC) is added thereto. Thus, an error correcting code (ECC) process is performed with respect to recording data in the flash memory and recording data on the hard disk so that an error correcting process can be performed at the reproduction time.

In the above device, portions of the flash memory interface 315 and flash memory 203 are used as a cache. In this case, the ECC process having higher error correction ability can be performed with respect to recording data on the hard disk rather than recording data in the flash memory.

The data writing sequence and data reading sequence are determined according to software stored in the controller 311. For example, when write data is transferred from the host device 100 to the hard disk 204, the data may be transferred via a path of host interface 202→controller 311→SDRAM interface 313→SDRAM 201→SDRAM interface 313→controller 311→disk interface 314→hard disk 204 or a path of host interface 202→controller 311→flash memory interface 315→flash memory 203→flash memory interface 315→controller 311→disk interface 314→hard disk 204. Further, the data can be transferred via a path of host interface 202→controller 311→flash memory interface 315→flash memory 203→flash memory interface 315→controller 311→SDRAM interface 313→SDRAM 201→SDRAM interface 313→controller 311→disk interface 314→hard disk 204.

When data is read from the hard disk 204 to the host device 100, the data may be read via a path of disk interface 314→controller 311→SDRAM interface 313→SDRAM 201→SDRAM interface 313→controller 311→host interface 312→host device or a path of disk interface 314→controller 311→flash memory interface 315→flash memory 203→flash memory interface 315→controller 311→host interface 312→host device. Further, the data can be read via a path of disk interface 314→controller 311→flash memory interface 315→flash memory 203→flash memory interface 315→controller 311→SDRAM interface 313→SDRAM 201→SDRAM interface 313→controller 311→host interface 312→host device.

<Explanation for Flash Memory>

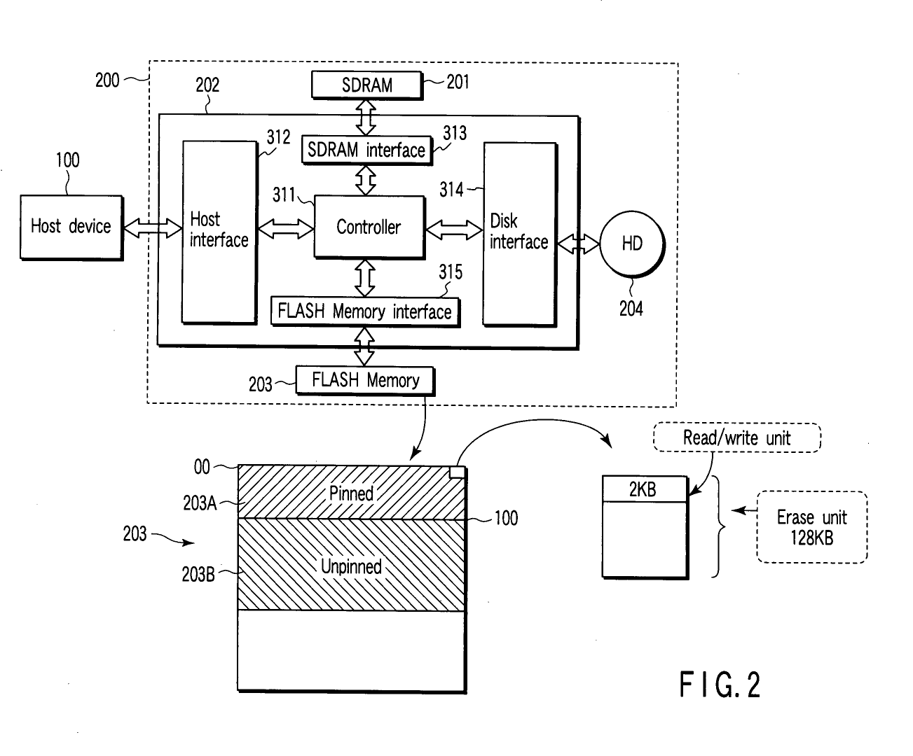

FIG. 2 is a diagram for illustrating the peculiar control operation in dealing with the flash memory 203. The flash memory 203 is a nonvolatile memory, but data can be electrically erased. Therefore, it is a data rewritable nonvolatile memory.

For example, the erase unit of the flash memory 203 is specified by 128 Kbytes. Further, the reading unit and writing unit are each specified by 2 Kbytes, for example. The elements of the flash memory 203 are degraded and the number of errors increases with an increase in the number of erasing operations. Therefore, as information which ensures the performance of the element, the number of rewriting times is specified to approximately 100,000 times. The number of bytes of the erase unit and the number of bytes of the writing unit are not limited to the above values. For example, the erase unit may be set to 23 Kbytes and the reading/writing unit may be set to 512 bytes.

<Basic Relation Between Flash Memory, Controller and Command from Host Device>

As shown in FIG. 2, when data is written into the flash memory 203, the write area can be divided into areas which are called a Pinned area 203A and Unpinned area 203B. The Pinned area 203A is an area which is formed when a data write destination-indicating command supplied from the host device 100 specifies the flash memory 203. The command contains a logical block address (LBA) of the flash memory 203, and a data write destination-indicating data for the flash memory 203. The Unpinned area 203B is an area which is formed when a data write destination-indicating command from the host device 100 is not specified and in which data is transferred and stored according to independent determination by the controller 311.

As data to be written into the flash memory 203, data supplied from the host device 100 or data read from the hard disk 204 is provided.

Various types of determination conditions for determining a data write destination by the controller 311 are provided. The state determining section of the controller 311 synthetically judges the conditions of the surroundings and determines the write destination. For example, the condition is set in a state which occurs immediately after the power supply of the device is turned ON and when the hard disk 204 does not reach a preset rotation speed or when the hard disk 204 is set in the stop state.

<Function and Configuration of Flash Memory Interface 315 and Controller 311>

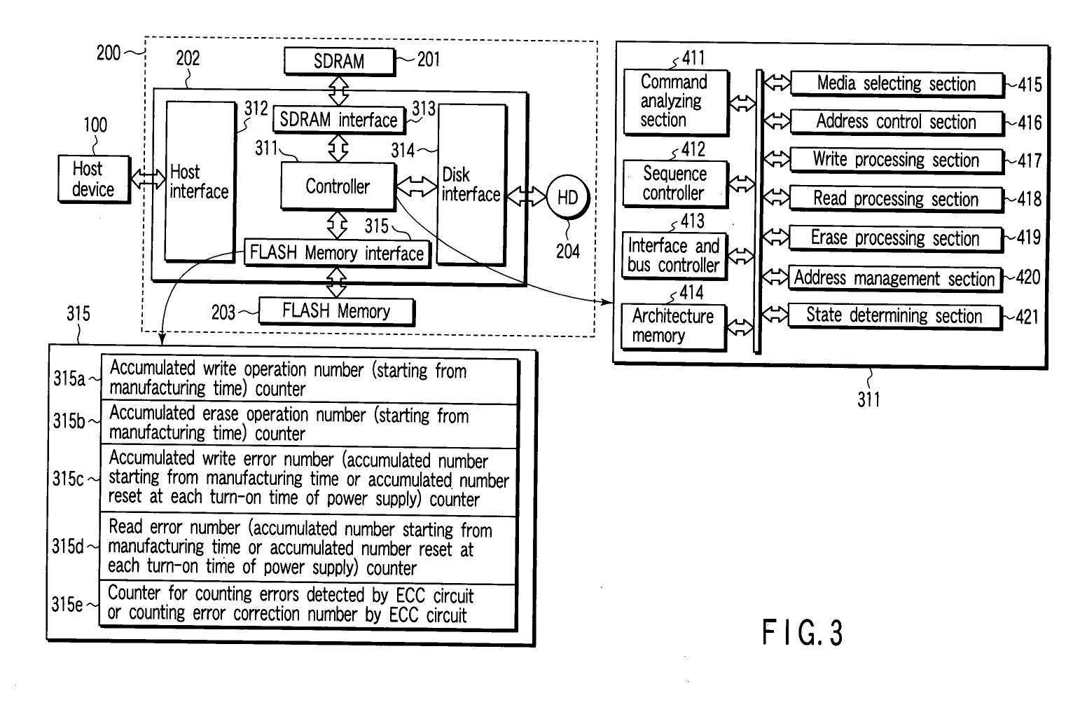

FIG. 3 shows the configurations of the controller 311 and flash memory interface 315 classified according to respective functions. An accumulation counter is provided in the flash memory interface 315, the count value thereof is written into a register provided in the interface, for example, and then written into the flash memory 203 or the flash memory 203 may be directly utilized.

As the counter, an accumulated write operation number counter 315a, accumulated erase operation number counter 315b, accumulated write error number counter 315c and read error number counter 315d are provided. Instead of the read error number counter 315d, an error number counter for counting errors detected by an ECC circuit or an error correction number counter 315e can be provided. Further, a counter which counts the reading/writing unit can be provided. The contents of the above counters are used as the determination factors of the state determining section which determines whether or not warning is issued when the number of errors becomes larger.

The controller 311 includes a command analyzing section 411 to decode and analyze a command supplied from the host device 100. It specifies software in an architecture memory 414 based on the analysis result of the command and sets an operation sequence in a sequence controller 412. Further, the command analyzing and control operation can be performed in the interface 312.

The sequence controller 412 controls the flow of data and control data via an interface and bus controller 413. For example, when the data write or read operation is performed, a media selecting section 415 specifies a flash memory 203 or hard disk (HD) 204 and an address control section 416 specifies a write address or read address. Then, at the data write time, a write processing section 417 performs a write data transfer process or the like. Further, at the data read time, a read processing section 418 performs a read data transfer process or the like.

In addition, an erase processing section 419 is provided. The erase processing section 419 performs the erase process for data of the flash memory 203. Further, the erase processing section 419 can perform the erase process for data of the hard disk 204.

An address management section 420 is provided. The address management section 420 collectively manages addresses of the hard disk 204 and addresses of the recorded area and unrecorded area of the flash memory 203. Since the flash memory 203 is used as a cache memory, it is unnecessary to pay attention to the address of the cache memory and set the address of the hard disk 204 side when the host device 100 side specifies the address. When a cache memory is specifically specified as a data storage destination, a Pinned command may be issued. If a Pinned command is not provided, the data storage destination is determined depending on the determination result of the firmware configured in the controller 311.

The address management and control operation for the Pinned area and Unpinned area of the flash memory 203 may be performed in the flash memory interface 315.

Further, a state determining section 421 is provided. The state determining section 421 monitors the state of the hard disk 204.

When the storage capacity of the flash memory 203 becomes larger than a certain threshold value, the controller 311 determines the state and performs a process of transferring and writing data to the hard disk 204. The operation performed at this time is mainly controlled by a combination of the read processing section 418, write processing section 416 and address management section 420.

<Peculiar Configuration, Function and Operation in Present Embodiment>

<Preposition> It is preferable to attain low power consumption in the above storage device. In order to attain this, the operation may preferably be managed to set the number of driving operations of the hard disk 204 as small as possible. If the management operation is performed to serve the above purpose, the number of accesses to the flash memory 203 will increase. If the management operation is performed to increase the number of write operations with respect to the flash memory 203, then there occurs a new problem that the service life of the flash memory 203 is shortened.

<Solving Measure> Therefore, in the present embodiment, the operation management is performed to suppress the service life of the flash memory 203 from being shortened while an attempt is made to lower the power consumption.

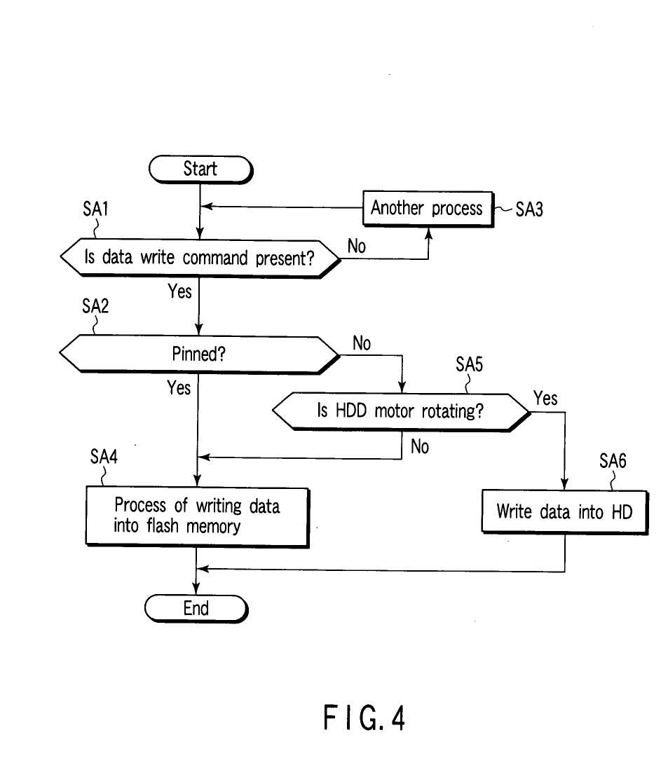

FIG. 4 is one example of a flowchart for illustrating the operation when the device performs the data writing process. The command analyzing section 411 analyzes a command supplied from the host device 100 and determines whether a data write command is provided or not (step SA1). If no data write command is provided, another process is performed (step SA3) and the process returns to step SA1.

If a data write command is provided, whether write data is Pinned data or not is determined (step SA2). If it is the Pinned data, the write processing section 418 writes data to the flash memory 203. If the write data is not Pinned data, whether the HDD motor (spindle motor) is being rotated or not is determined by the state determining section 421 (step SA5). If the spindle motor is not being rotated, the write processing section 418 writes write data (corresponding to an Unpinned area) into the flash memory. If the hard disk drive (HDD) motor is being rotated, the write processing section 418 writes write data to the hard disk 204. As the determining condition for permitting data to be written into the hard disk 204, whether the service life of the flash memory 203 comes close to the end or not is determined and if the service life comes close to the end, data may be written into the hard disk 204.

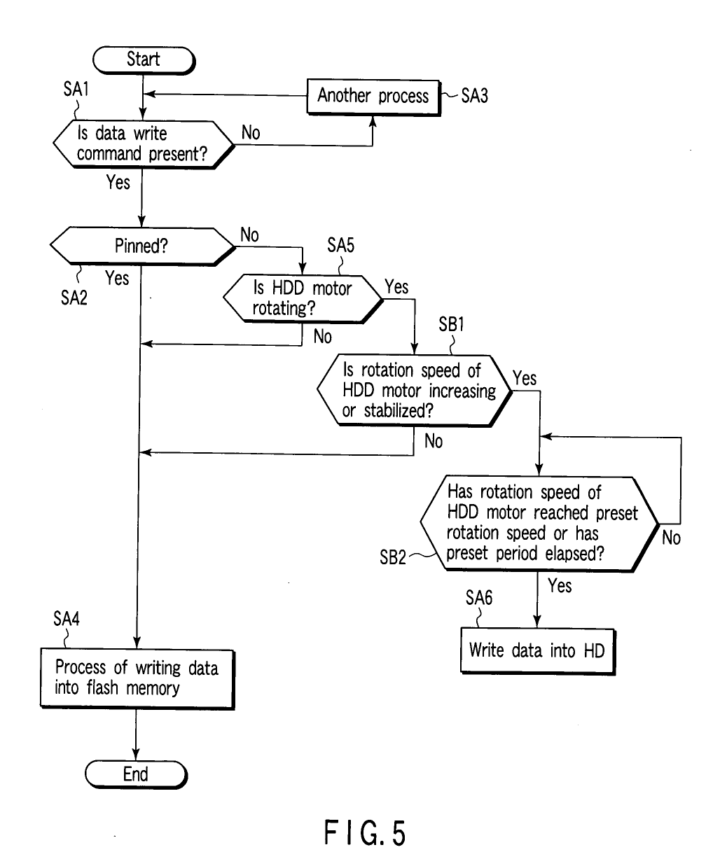

FIG. 5 is a flowchart for illustrating another example of the operation when the device performs the data write process. In FIG. 5, portions which are the same as those of the flowchart of FIG. 4 are denoted by the same reference symbols. In the present embodiment, even when it is determined in step SA5 that the spindle motor is being rotated, the state of rotation of the motor is monitored. This is because the spindle motor will be continuously rotated by inertia after a stop command is issued even if the spindle motor is being rotated. Therefore, in the present embodiment, whether the rotation speed of the motor is increasing or stabilized is determined (step SB1). If the above condition is not satisfied, the write processing section 417 writes write data to the flash memory 203.

If it is determined in step SB1 that the motor is increasing or stabilized, the write processing section 417 writes data to the hard disk after the rotation speed of the motor has reached a preset rotation speed or a preset period has elapsed.

Whether the rotation speed of the motor is increasing or not is determined based on whether or not a preset period has elapsed after the spindle motor was triggered. Further, whether or not the rotation speed of the motor is stabilized can be determined based on the condition that a preset period has elapsed after the spindle motor was triggered and a stop command is not issued. Further, the frequency of a rotation detection signal of the spindle motor may be determined on the hard disk 204 side. The rotation detection signal is used in a servo circuit of the spindle motor, and therefore, the rotation detection signal is monitored.

<Effective Influence>

By performing the above management operation, the number of new drive operations of the hard disk 204 can be set as small as possible. Therefore, the low power consumption can be attained. Further, the number of accesses to the flash memory 203 can be suppressed. As a result, the service life of the flash memory 203 can be made longer.

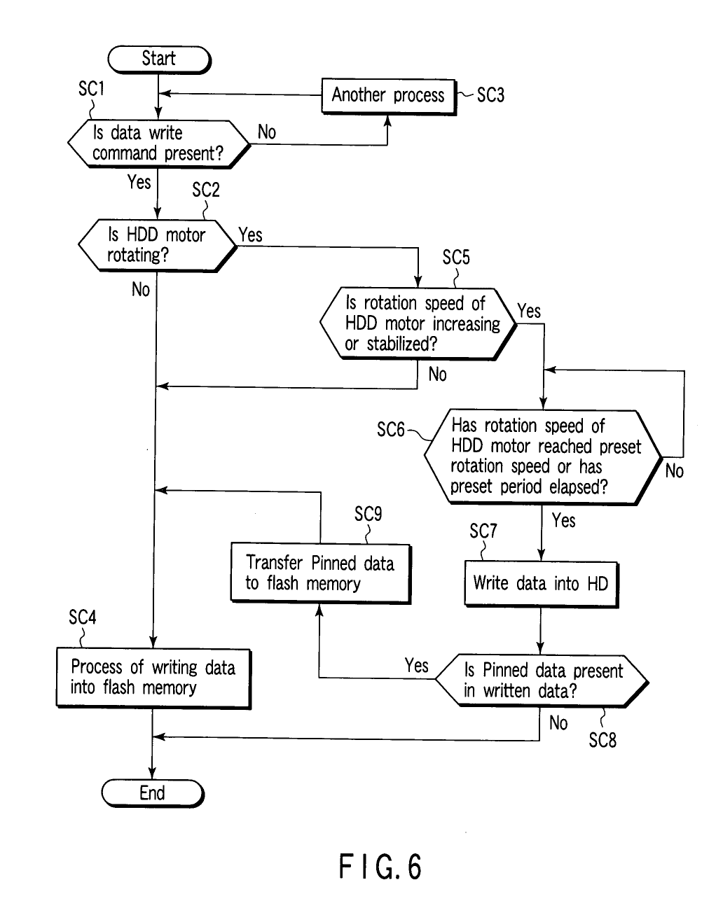

FIG. 6 is a flowchart for illustrating still another example of the operation when the device performs the data write process. In the present embodiment, when a data write command is input (step SC1), whether or not a spindle motor (corresponding to a hard disk motor) is being rotated is first determined (SC2). When the spindle motor is not being rotated, the write processing section 417 writes write data to the flash memory 203. When the spindle motor is being rotated, whether the rotation speed of the motor is increasing or stabilized is determined (step SC5).

If it is determined that the rotation speed of the spindle motor has reached a preset rotation speed or a preset period has elapsed after the motor was triggered, the write processing section 417 writes data to the hard disk 204 (step SC7). At this time, whether or not data written into the hard disk 204 is data to be written into the Pinned area is determined SC8. Whether the data is Pinned data or not can be determined by temporarily holding the attributes of the write command and checking the same after data is written. If the Pinned data is present, the data is transferred to and written into the flash memory 203 (step SC9). When the Pinned data is not present, the process is terminated.

The above device can realize the low power consumption and high-speed read/write operation and the service life of the storage device which is a semiconductor memory can be made longer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device using a nonvolatile cache memory, comprising:
a host interface,
a command analyzing section which analyzes contents of a command input from the host interface,
a memory interface acting as an interface with respect to a cache memory,
a state determining section which determines a rotation state of a hard disk when a command analyzed by the command analyzing section is a command for instructing data writing, and
a write processing section which transfers write data to the hard disk when a determination result of the state determining section indicates that the hard disk is being rotated and transfers the write data to the cache memory when the determination result indicates that the hard disk is not being rotated.

2. The storage device using the nonvolatile cache memory according to claim 1, wherein the write processing section transfers write data to the hard disk when the determination result of the state determining section indicates that the hard disk is being rotated and a rotation speed of a spindle motor is set in one of an increasing state and stabilized state.

3. The storage device using the nonvolatile cache memory according to claim 1, wherein the write processing section determines that a spindle motor is being rotated at a preset rotation speed and transfers write data to the hard disk when the determination result of the state determining section indicates that the hard disk is being rotated and the rotation speed of the spindle motor is stabilized.

4. The storage device using the nonvolatile cache memory according to claim 1, wherein the write processing section determines whether the hard disk is being rotated by interpreting a command issued to the hard disk.

5. The storage device using the nonvolatile cache memory according to claim 1, wherein the write processing section determines whether the hard disk is being rotated by using a rotation detecting signal of a spindle motor of the hard disk.

6. A control method for a storage device which includes a host interface, a disk interface, a flash memory interface, a controller which controls an operation and a cache memory, comprising:
analyzing contents of a command input from the host interface,
determining a rotation state of a hard disk when an analyzed command is a command for instructing data writing, and
transferring write data to the hard disk when a determination result of the rotation state indicates that the hard disk is being rotated and transferring the write data to the cache memory when the determination result indicates that the hard disk is not being rotated.

7. The control method for the storage device according to claim 6, further comprising transferring write data to the hard disk when the determination result of the rotation state indicates that the hard disk is being rotated and a rotation speed of a spindle motor is set in one of an increasing state and stabilized state.

8. The control method for the storage device according to claim 6, further comprising determining that a spindle motor is being rotated at a preset rotation speed and transferring write data to the hard disk when the determination result of the rotation state indicates that the hard disk is being rotated and the rotation speed of the spindle motor is stabilized.

9. The control method for the storage device according to claim 6, wherein the determining whether the hard disk is being rotated is made by interpreting a command issued to the hard disk.

10. The control method for the storage device according to claim 6, wherein the determining whether the hard disk is being rotated is made by using a rotation detecting signal of a spindle motor of the hard disk.
